(19) United States
(12) Patent Application Publication
(10) Pub. No.: US 2026/0088689 A1
(43) Pub. Date: Mar. 26, 2026

(54) COIL STRIPPING APPARATUS FOR MANUFACTURE OF HAIRPIN FOR MOTOR OF ELECTRIC VEHICLE

(71) Applicants: Hyundai Motor Company, Seoul (KR); Kia Corporation, Seoul (KR); Pyeong Hwa Technology Co., Ltd., Changwon (KR); Hyundai Mobis Co., Ltd., Seoul (KR)

(72) Inventors: Kyoung Min Park, Hwaseong (KR); Chanui Park, Hwaseong (KR); Seungwon Song, Hwaseong (KR); Won Il Kim, Hwaseong (KR); Kyung Seok Yoo, Changwon (KR); Taek Soo Yang, Changwon (KR); Yong Seok Lim, Changwon (KR); Min Soo Kang, Seoul (KR)

(21) Appl. No.: 19/209,943

(22) Filed: May 16, 2025

(30) Foreign Application Priority Data
Sep. 26, 2024 (KR) 10-2024-0130620

(51) Int. Cl. H02K 15/50; H02K 15/0421

(52) U.S. Cl. CPC H02K 15/50; H02K 15/0421; H02K 2215/00

(57) ABSTRACT

A coil stripping apparatus is configured for manufacture of a hairpin for a motor of an electric vehicle. The coil stripping apparatus includes a base frame provided with a guide rail having a straight path, at least two stripping units configured to press both sides of the material coil while moving along the guide rail to remove an insulating film, and a controller configured to control movement and operation of the stripping units. The stripping units include a first stripping unit disposed upstream based on a material coil feeding path and a second stripping unit disposed downstream of the first stripping unit.

### CROSS-REFERENCE TO RELATED APPLICATION

The present application claims under 35 U.S.C. § 119 (a) the benefit of Korean Patent Application No. 10-2024-0130620 filed on Sep. 26, 2024, the entire contents of which are incorporated herein by reference.

### BACKGROUND

### (a) Technical Field

The present disclosure relates to a coil stripping apparatus for manufacture of a hairpin for a motor of an electric vehicle, more particularly, to the coil stripping apparatus configured to remove an insulating film from a predetermined portion of an outer periphery of a material coil having a rectangular cross-section, thereby exposing a conductive core.

### (b) Description of the Related Art

A motor is a core part of electric vehicles. A motor includes a stator and a rotor. A motor is a device that generates mechanical energy using electric energy by inducing rotational motion of a rotor relative to a stator. Generally, the stator is wound with a highly conductive copper wire. When alternating current (AC) flows through the copper wire, a magnetic field is formed around the stator. The rotor may be a steel core and/or a magnet, and rotates under the influence of the magnetic field formed around the stator. The motor converts the electric energy supplied to the stator into kinetic energy for rotation of the rotor.

As the density per unit volume of the copper wire wound on the stator increases, the efficiency and performance of the motor is improved. Therefore, the copper wire may be formed as a linear member having a rectangular cross-section in order to more densely wind the copper wire on the stator.

In addition, in order to improve the performance and efficiency of a motor, a motor equipped with a hairpin-type stator, which is manufactured by transforming a copper wire, cut to a predetermined length, into a hairpin type and then mounting the hairpin in a stator slot, is widely used.

The hairpin is manufactured by processing a linear copper coil having a rectangular cross-section. A thin insulating film is coated on the surface of the linear copper coil. The insulating film may be formed by coating an insulative material such as enamel on the surface of the copper coil.

A plurality of hairpins is inserted into stator slots, and is arranged in an elaborately designed pattern. Each of the hairpins includes an insulated portion for preventing electrical short circuit with another hairpin adjacent thereto and an insulating-film-removed portion for achieving electrical connection to a circuit.

Conventionally, a hairpin is manufactured through a process of feeding a linear copper coil in one direction, a process of removing an insulating film from a predetermined portion of the linear copper coil, and a process of cutting the linear copper coil in units of predetermined length based on the insulating-film-removed portion.

However, according to the related art in which the copper coil is cut after the insulating film is removed therefrom, it is not possible to precisely adjust the length of each hairpin and the position of an insulating-film-removed portion in each hairpin.

### SUMMARY

An aspect of the present disclosure is directed to a motor for an electric vehicle, in particular, to solving a problem with the related art that, when a process of removing an insulating film from the surface of a material coil or a notching process is performed, a processing tolerance is relatively large due to the pressure of a press.

Another aspect of the present disclosure is directed to solving a problem with the related art that the thickness of an insulating film removed from a material coil having a rectangular cross-section is not uniform, so a portion of the material coil having undergone stripping and notching processes has an irregular cross-sectional shape.

Still another aspect of the present disclosure is directed to solving a problem with the related art that, in order to prevent deterioration in processing quality due to processing chips generated during stripping and notching processes, processing processes must be frequently interrupted for the purpose of removing the processing chips.

The aspects of the present disclosure are not limited to those mentioned above, and other aspects or objects not mentioned herein will be clearly understood by those skilled in the art from the following description.

A coil stripping apparatus according to an embodiment of the present disclosure is configured to remove an insulating film from a surface of a material coil to manufacture a hairpin for a motor. The coil stripping apparatus may include a base frame provided on an upper surface thereof with a guide rail; at least two stripping units provided to be movable along the guide rail, the at least two stripping units being configured to face and press both sides of the material coil fed horizontally to remove an insulating film coated on the material coil; and a controller configured to control movement and operation of the at least two stripping units on the base frame, wherein the at least two stripping units comprise: a first stripping unit disposed upstream based on a feeding path of the material coil; and a second stripping unit disposed downstream of the first stripping unit.

In aspects, suitably the guide rail has a straight path.

According to another aspect, a coil stripping apparatus for manufacture of a hairpin according to an embodiment of the present disclosure is an apparatus that removes an insulating film from the surface of a material coil to expose a conductive core, and includes a base frame provided on an upper surface thereof with a guide rail having a straight path, at least two stripping units provided to be movable along the guide rail, the at least two stripping units being configured to face and press both sides of the material coil fed horizontally to remove an insulating film coated on the material coil, and a controller configured to control movement and operation of the at least two stripping units on the base frame, wherein the at least two stripping units include a first stripping unit disposed upstream based on a feeding path of the material coil, the first stripping unit being configured to press an upper portion and a lower portion of the material coil to remove predetermined portions of the insulating film from an upper surface and a lower surface of the material coil, and a second stripping unit disposed downstream of the first stripping unit, the second stripping unit being configured to press both sides of the material coil to remove predetermined portions of the insulating film from both side surfaces of the material coil.

In the coil stripping apparatus for manufacture of a hairpin according to the embodiment of the present disclosure, each of the first stripping unit and the second stripping unit may include a main plate movably coupled to the guide rail, an operating box coupled to an upper side of the main plate, the operating box being equipped with a vice holder configured to reciprocate along a predetermined straight path in accordance with operation of a servomotor, a fixed die fixed to the main plate, the fixed die being provided on one surface thereof with a processing unit, and a movable die connected to the vice holder to repeat operation of approaching and moving away from the processing unit.

In the coil stripping apparatus for manufacture of a hairpin according to the embodiment of the present disclosure, the first stripping unit may press two opposite surfaces of the material coil in a Z-axis straight direction vertically perpendicular to an X-axis straight direction in which the material coil is fed, and the second stripping unit may press two opposite surfaces of the material coil in a Y-axis straight direction perpendicular both to the X-axis straight direction and to the Z-axis straight direction.

In the coil stripping apparatus for manufacture of a hairpin according to the embodiment of the present disclosure, the movable die may include a processing tool provided on a surface thereof facing the processing unit so as to press the material coil together with the processing unit to remove the insulating film.

In the coil stripping apparatus for manufacture of a hairpin according to the embodiment of the present disclosure, each of the first stripping unit and the second stripping unit may further include a pair of vice clamps configured to secure the material coil when a distance between the movable die and the fixed die is shorter than a predetermined distance, and the processing unit and the processing tool may be located between the pair of vice clamps.

In the coil stripping apparatus for manufacture of a hairpin according to the embodiment of the present disclosure, the pair of vice clamps may include a pair of lifting blocks coupled to the movable die, with the processing tool interposed therebetween, and a pair of alignment blocks provided at the fixed die, with the processing unit interposed therebetween, so as to respectively correspond to the pair of lifting blocks.

In the coil stripping apparatus for manufacture of a hairpin according to the embodiment of the present disclosure, each of the pair of alignment blocks may include a holding block having a coil feeding path formed therein as a passage through which the material coil passes, a reference block provided in contact with one side of the holding block, and a press block provided opposite the reference block so as to be in contact with another side of the holding block. As the lifting block approaches the alignment block, the lifting block may press the reference block and the press block toward the holding block from both sides.

In the coil stripping apparatus for manufacture of a hairpin according to the embodiment of the present disclosure, each of the pair of alignment blocks may further include a restoring unit configured to push the reference block and the press block in opposite directions toward original positions thereof when a gap between the reference block and the press block is less than a predetermined gap.

In the coil stripping apparatus for manufacture of a hairpin according to the embodiment of the present disclosure, the processing unit may include at least one processing blade and a cavity formed around the at least one processing blade as a passage for discharge of a chip.

In the coil stripping apparatus for manufacture of a hairpin according to the embodiment of the present disclosure, the movable die may include at least one air hole formed therein to inject air into the cavity.

A vehicle may include the motor having the hairpin manufactured using the coil stripping apparatus.

An electric vehicle may include the motor having the hairpin manufactured using the coil stripping apparatus.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 is a view for explaining a hairpin of a motor that is manufactured through a coil stripping apparatus according to an embodiment of the present disclosure;

FIG. 2 is a perspective view for explaining a material coil wound on a winding bobbin;

FIG. 3 is a flowchart for explaining a process of manufacturing a hairpin of a motor;

FIG. 4 is a hairpin manufacturing process diagram schematically showing the process of manufacturing a hairpin of a motor using a coil stripping apparatus according to an embodiment of the present disclosure;

FIG. 5 is a front view of a coil stripping apparatus according to an embodiment of the present disclosure;

FIG. 6 is a perspective view of the coil stripping apparatus according to the embodiment of the present disclosure;

FIG. 7 is a schematic view for explaining the operational state of vice clamps in the coil stripping apparatus according to the embodiment of the present disclosure;

FIG. 8 is a bottom perspective view of a movable die in the coil stripping apparatus according to the embodiment of the present disclosure;

FIG. 9 is a block diagram schematically showing a path through which air is injected into a processing unit in the coil stripping apparatus according to the embodiment of the present disclosure; and

FIGS. 10 and 11 are views schematically showing a process in which a conductive terminal is formed at an end of a material coil by the coil stripping apparatus according to the embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings.

In the following description of the embodiments disclosed in the present specification, a detailed description of known functions and configurations incorporated herein will be omitted when the same may make the subject matter of the embodiments disclosed in the present specification rather unclear.

In addition, the accompanying drawings are provided only for a better understanding of the embodiments disclosed in the present specification and are not intended to limit the technical ideas disclosed in the present specification.

It will be understood that when a component is referred to as being “connected to” or “coupled to” another component, it may be directly connected to or coupled to the other component, or intervening components may be present.

The first direction X, the second direction Y, and the third direction Z described herein refer to respective dimensions and directions of a three-dimensional coordinate system for describing a three-dimensional shape. Thus, the first direction X, the second direction Y, and the third direction Z may be indicated by arrows intersecting each other perpendicularly at one point in space.

The present disclosure relates to an apparatus 66 for removing an insulating film 59 for manufacture of a hairpin 10 of a motor.

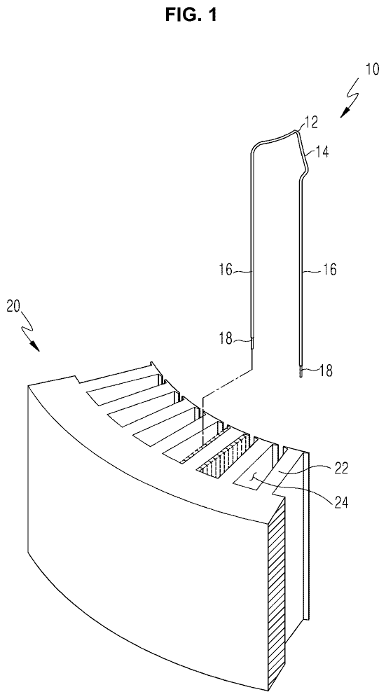

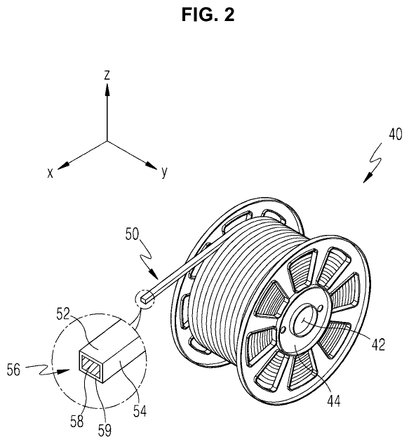

FIG. 1 is a view for explaining a hairpin 10 of a motor that is manufactured through an apparatus 66 for removing an insulating film 59 according to an embodiment of the present disclosure, and FIG. 2 is a perspective view for explaining a material coil 50 wound on a winding bobbin 40.

Referring to FIGS. 1 and 2, an electric motor includes a stator 20 and a rotor.

Generally, the stator 20 is a fixed part of the motor. A material coil 50 may be wound on a stator core 22 in a predetermined direction.

As shown in the drawings, the material coil 50 may have a shape of a hairpin 10. The stator core 22 may be provided in plural, and the plurality of stator cores 22 may be disposed at regular intervals. Stator slots 24 are formed between the stator cores 22. The material coil 50 may be cut to a predetermined length, and the cut material coil may be transformed into the hairpin 10. Each of a plurality of hairpins 10 may be accommodated in a respective one of the stator slots 24.

The hairpins 10 manufactured through cutting and processing of the material coil 50 may be mounted to the stator 20 of the electric motor, as described above.

When current is applied to the hairpin 10, a magnetic field is formed around the stator 20. Then, the rotor rotates relative to the stator 20 under the influence of the magnetic field formed around the stator 20.

The coil stripping apparatus 66 according to the embodiment of the present disclosure may be utilized in a process of manufacturing the hairpin 10.

The hairpin 10 is manufactured by processing the material coil 50 cut to a predetermined length. Alternatively, in some embodiments of the present disclosure, in order to manufacture the hairpin 10, bending, stripping, and notching processes may be performed in advance on some portions of the material coil 50, and then a process of cutting the material coil 50 having undergone the above processes to a predetermined length may be performed.

The material coil 50 is formed as a linear conductor having a rectangular cross-section.

In detail, the material coil 50 includes a conductive core 58 made of a conductive material and an insulating film 59 coated on the surface of the conductive core 58. The conductive core 58 may be a linear copper member having a rectangular cross-section, and the insulating film 59 may be an insulative material, such as enamel, coated on the surface of the conductive core 58 as a layer having a predetermined thickness.

The hairpin 10 is manufactured by cutting the linear material coil 50 to a predetermined length, and a pair of conductive terminals 18 is formed at respective ends of the hairpin 10. The pair of conductive terminals 18 is formed at respective ends of the hairpin 10 so as to have a predetermined length. The conductive terminals 18 are portions of the material coil 50 from which the insulating film 59 is removed so that portions of the conductive core 58 are exposed to the outside, thereby serving as terminals for electrical connection.

The hairpin 10 may be divided into a pin head 12, pin shoulders 14, pin arms 16, and the aforementioned conductive terminals 18.

The pin head 12 is a center portion of the hairpin 10, and corresponds to a vertex portion bent at a predetermined angle.

The pin head 12 is a point at which the pair of pin shoulders 14 meets each other. The pair of pin shoulders 14 corresponds to linear portions extending bilaterally from the pin head 12.

Based on the state in which the sharp bent portion of the pin head 12 is directed upward as shown in FIG. 1, the pair of pin shoulders 14 may correspond to two sides of a virtual triangle that form a contained angle therebetween, with the vertex of the angle being the pin head 12, in the plan view and the front view.

The pin arms 16 are formed at the ends of the respective pin shoulders 14. The pin arms 16 are linear portions extending straight in an upward-downward direction, based on FIG. 1, and the conductive terminals 18 are formed at the lower ends of the respective pin arms 16.

The two pin arms 16 may be disposed parallel to each other.

The material coil 50 used for manufacture of the hairpin 10 is a linear member having a rectangular cross-section, and may be stored and transported in the state of being wound on a winding bobbin 40, as shown in FIG. 2.

The winding bobbin 40 may include a bobbin core 44 having a cylindrical shape, shielding plates mounted on respective ends of the bobbin core 44, and a center hole 42 as a through-hole formed through the center of the bobbin core 44 in the longitudinal direction of the bobbin core 44.

The material coil 50 having a rectangular cross-section includes a long side portion 52 having a relatively long length and a short side portion 54 having a relatively short length.

The pair of pin shoulders 14 is portions extending straight bilaterally from the pin head 12. That is, the pair of pin shoulders 14 extends at a predetermined angle bilaterally from the pin head 12.

The pair of pin arms 16 is linear members extending from the ends of the respective pin shoulders 14. The pair of pin arms 16 is disposed parallel to each other, and the conductive terminals 18 are formed at the ends of the respective pin arms 16.

In detail, the hairpin 10 may be manufactured by processing the material coil 50 cut to a predetermined length.

Portions of the insulating film 59 are removed by a predetermined length from both ends of the material coil 50 cut to a predetermined length, thereby forming the conductive terminals 18 at both ends of the material coil 50.

In addition, a straight portion between the pair of conductive terminals 18 undergoes a bending process so as to have a predetermined three-dimensional shape, so the pin head 12, the pin shoulders 14, and the pin arms 16 are formed. Through the above processes, one hairpin 10 is manufactured.

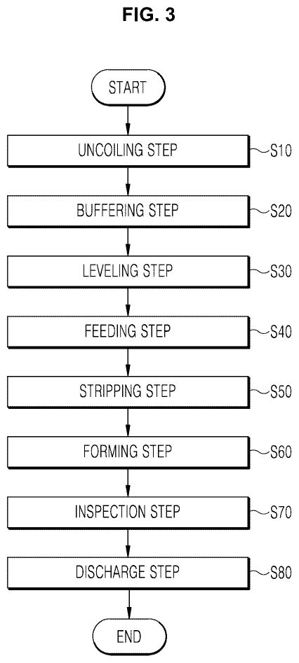

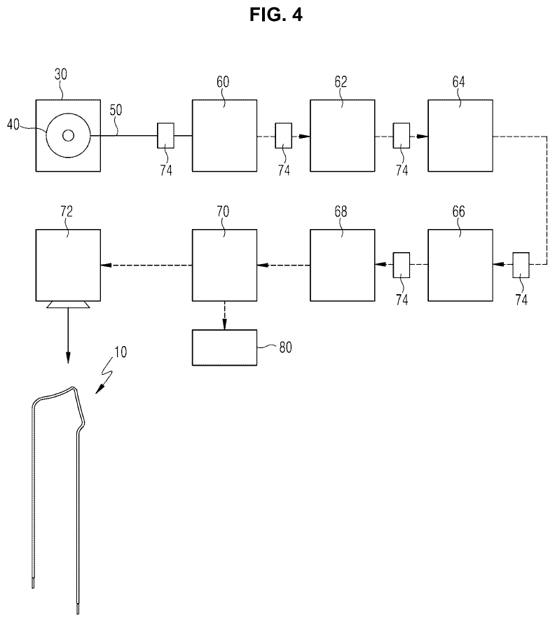

FIG. 3 is a flowchart for explaining a process of manufacturing the hairpin 10 of a motor, and FIG. 4 is a hairpin manufacturing process diagram schematically showing the process of manufacturing the hairpin 10 of a motor using the apparatus 66 for removing the insulating film 59 according to the embodiment of the present disclosure.

As shown in FIGS. 3 and 4, the process of manufacturing the hairpin 10 may include an uncoiling step S10, a buffering step S20, a leveling step S30, a feeding step S40, a stripping step S50, a forming step S60, an inspection step S70, and a discharge step S80.

The uncoiling step S10 is a step of unwinding the material coil 50 having a rectangular cross-section from the winding bobbin 40 using an uncoiling apparatus 30 and feeding the unwound material coil 50 straight from one end of the winding bobbin 40.

The buffering step S20 is a step of storing the material coil 50 unwound from the winding bobbin 40 and fed straight so that the material coil 50 is fed without delay by unit length for manufacture of the hairpin 10. That is, the buffering step S20 is a step of sufficiently securing the length of the unwound material coil 50, which is capable of being fed, to a predetermined length or longer using a buffering apparatus 60.

The leveling step S30 is a step of straightening the material coil 50 unwound from the winding bobbin 40 using a leveling apparatus 62.

The feeding step S40 may be performed through a feeding apparatus 64. The feeding apparatus 64 holds the material coil 50 and feeds the material coil 50 by a predetermined unit length in a predetermined direction.

The stripping step S50 is a step of removing the insulating film 59, such as enamel, coated on the surface of the material coil 50. The stripping step S50 may be performed through the stripping apparatus 66, and may further include a notching process for the conductive terminals 18 that are formed through removal of the insulating film 59.

The forming step S60 is a step of cutting the material coil 50 to a “set length”, which is a length of the material coil 50 for manufacture of each hairpin 10, and bending the material coil 50 cut to the set length using a forming apparatus 68, thereby forming the pin head 12, the pin shoulders 14, and the pin arms 16.

The inspection step S70 is a step of inspecting the hairpin 10 having undergone the forming step S60 using an inspection apparatus 70 to determine whether the hairpin 10 is a non-defective product or a defective product.

The discharge step S80 is a step of feeding the hairpin 10 determined to be a non-defective product in the inspection step S70 to a discharge apparatus 72. The hairpin 10 determined to be a non-defective product is fed to a predetermined position along the discharge apparatus 72.

Feeding guides 74 may be provided between the apparatuses for performing the above-described respective processes in order to correct the direction and position of the material coil 50 that is fed between the apparatuses.

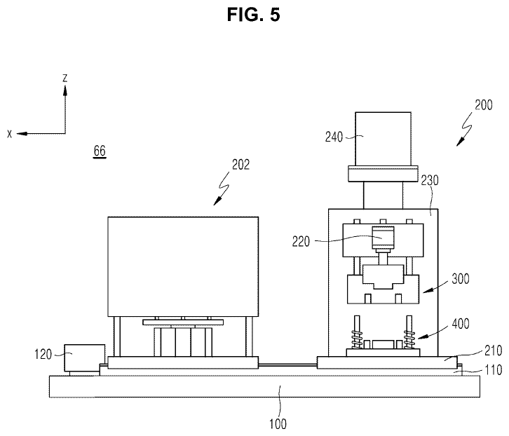

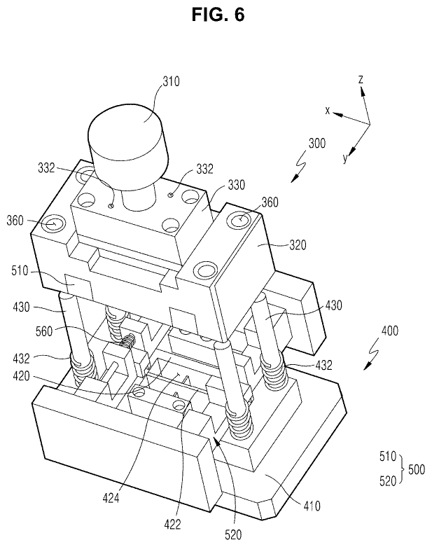

FIG. 5 is a front view of the apparatus 66 for removing the insulating film 59 according to an embodiment of the present disclosure, and FIG. 6 is a perspective view of the apparatus 66 for removing the insulating film 59 according to the embodiment of the present disclosure.

As shown in FIGS. 5 and 6, the apparatus 66 for removing the insulating film 59 according to the embodiment of the present disclosure may include a base frame 100, a stripping unit, and a controller.

The base frame 100 is a structure firmly fixed to the floor, and the upper surface thereof may be flat in a horizontal direction.

The base frame 100 includes a guide rail 110 formed to be elongated in one direction.

The guide rail 110 may be composed of a pair of straight rails that is provided parallel to each other on the base frame 100 and forms a straight path.

In the embodiment of the present disclosure, the guide rail 110 is provided on the upper surface of the base frame 100 and is formed to be straight in the X-axis longitudinal direction.

The stripping unit is coupled to the guide rail 110. The stripping unit may include a first stripping unit 200 and a second stripping unit 202.

Each of the first stripping unit 200 and the second stripping unit 202 is provided so as to linearly reciprocate along the guide rail 110, and faces and presses two opposite sides of the material coil 50 fed horizontally in the X-axis direction to remove the insulating film 59 coated on the material coil 50.

Based on the feeding path of the material coil 50 fed in the X-axis longitudinal direction, the first stripping unit 200 is disposed upstream of the second stripping unit 202. The second stripping unit 202 is disposed downstream of the first stripping unit 200.

The first stripping unit 200 presses the fed material coil 50 from above and below to remove predetermined portions of the insulating film 59 from the upper surface and the lower surface of the material coil 50.

The second stripping unit 202 is disposed such that a coil feeding path 542 thereof, which is a path along which the material coil 50 is fed in the X-axis longitudinal direction, is located on the same straight line as a coil feeding path 542 of the first stripping unit 200. However, based on a virtual straight line along which the coil feeding path 542 extends, the second stripping unit 202 is mounted on the guide rail 110 so as to be oriented perpendicular to the first stripping unit 200.

The second stripping unit 202 presses the fed material coil 50 from the left and the right to remove predetermined portions of the insulating film 59 from the left surface and the right surface of the material coil 50.

The controller is mounted on the base frame 100, and controls movement and operation of the first stripping unit 200 and the second stripping unit 202.

The first stripping unit 200 and the second stripping unit 202 are mounted on main plates 210 coupled to the guide rail 110.

The main plates 210 are connected to a feeding motor 120, and linearly reciprocate on the path guided by the guide rail 110 under the control of the controller.

Each of the first stripping unit 200 and the second stripping unit 202 may be mounted on a respective one of the two main plates 210. The controller controls the feeding motor 120, thereby adjusting the positions of the first stripping unit 200 and the second stripping unit 202 and the gap therebetween.

In the embodiment of the present disclosure, the description of the configuration and coupling relationship of the first stripping unit 200 may also be equally applied to the second stripping unit 202. However, the first stripping unit 200 and the second stripping unit 202 are mounted so as to press the material coil 50 in an upward-downward direction and a leftward-rightward direction, respectively.

In detail, the first stripping unit 200 presses the lower surface of the material coil 50 in the +Z-axis direction from below the material coil 50 and presses the upper surface of the material coil 50 in the −Z-axis direction from above the material coil 50, thereby removing predetermined portions of the insulating film 59 from the lower and upper surfaces of the material coil 50.

The second stripping unit 202 is disposed downstream of the first stripping unit 200, and is mounted to allow the material coil 50 having passed through the coil feeding path 542 of the first stripping unit 200 to pass straight through the coil feeding path 542 formed in the second stripping unit 202. In addition, based on the feeding direction of the material coil 50, the second stripping unit 202 presses the right surface of the material coil 50 in the +Y-axis direction from the right and presses the left surface of the material coil 50 in the −Y-axis direction from the left, thereby removing predetermined portions of the insulating film 59 from the right and left surfaces of the material coil 50.

The first stripping unit 200 may include main plates 210, an operating box 230, a fixed die 400, and a movable die 300.

The main plates 210 are coupled to the guide rail 110 and move along the straight path of the guide rail 110. The main plates 210 may be moved by the feeding motor 120 mounted on the base plate.

The main plates 210 are structures that move along the guide rail 110. At least two main plates 210 may be coupled to the upper side of the guide rail 110.

The first stripping unit 200 may be mounted on the main plate 210 disposed upstream of the other main plate 210, and the second stripping unit 202 may be mounted on the main plate 210 disposed downstream of the other main plate 210.

The operating box 230 provided at the first stripping unit 200 includes a vice holder 220 configured to ascend and descend and a servomotor 240 configured to provide driving force allowing the vice holder 220 to linearly reciprocate relative to the operating box 230.

The movable die 300 is coupled to the vice holder 220 to move along with movement of the vice holder 220. The movable die 300 includes a grip knob 310, a main frame 320, a sub-frame 330, a processing tool 340, and a coil guide 350.

The main frame 320 and the sub-frame 330 support the processing tool 340 coupled to the lower surfaces thereof, and are made of a sufficiently highly rigid material so as not to be deformed or damaged by force acting between the vice holder 220 and the fixed die 400.

The main frame 320 and the sub-frame 330 may be firmly coupled to each other, and the grip knob 310 may extend upward from the main frame 320 and/or the sub-frame 330.

The grip knob 310 is coupled to the vice holder 220. The movable die 300 is fixed to the vice holder 220 through the grip knob 310 and thus moves together with the vice holder 220.

A plurality of guide holes 360 may be formed in the main frame 320. In the embodiment of the present disclosure, four guide holes 360 may be formed at positions adjacent to the outermost edge of the main frame 320.

Each of the guide holes 360 may be a circular through-hole formed through the main frame 320 in the upward-downward direction.

In addition, the processing tool 340 is coupled to the lower surface of the main frame 320 and/or the sub-frame 330. The processing tool 340 is disposed such that a processing surface thereof faces downward so as to come into contact with the surface of the material coil 50.

The processing tool 340 may include a processing surface that removes the insulating film 59 from the surface of the material coil 50 that is in contact with the processing surface. The processing tool 340 may be separated from the movable die 300 so as to be independently replaced.

The processing tool 340 may be fixed to the center of the lower surface of the main frame 320, and a pair of lifting blocks 510 constituting vice clamps 500 may be provided on both sides of the processing tool 340.

The lifting blocks 510 may be provided at the front and rear of the processing tool 340 in the feeding direction of the material coil 50. The lifting blocks 510 may be detachably coupled to the main frame 320.

The fixed die 400 includes a fixed plate 410, a processing unit 420, a guide post 430, and an elastic unit 432.

The fixed plate 410 is mounted such that one surface thereof faces the surface of the main frame 320 on which the processing tool 340 is mounted. The fixed plate 410 is coupled to the upper side of the main plate 210 to move together with the main plate 210.

The processing unit 420 is provided at the center of one surface of the fixed plate 410. The processing unit 420 is disposed to face the processing tool 340. If the processing tool 340 linearly reciprocates along a predetermined straight path, the processing tool 340 repeats operation of contacting and pressing the processing unit 420 and then moving away from the processing unit 420.

The processing unit 420 of the first stripping unit 200 is fixed to the fixed die 400 such that a surface thereof on which a processing blade 422 is formed faces in the +Z-axis direction. In addition, the processing tool 340 is fixed to the movable die 300 such that the processing surface thereof faces the −Z-axis direction so as to face the surface of the processing unit 420 on which the processing blade 422 is formed.

The processing tool 340 reciprocates along a predetermined straight path together with the vice holder 220 and the movable die 300, which linearly reciprocates relative to the operating box 230. Thus, the processing tool 340 repeats operation of approaching and moving away from the processing unit 420 in the +Y-axis straight direction along the path including a path in which the processing surface of the processing tool 340 contacts and presses the surface of the processing unit 420 on which the processing blade 422 is formed.

The material coil 50 is disposed between the processing tool 340 and the processing unit 420 in the process in which the processing tool 340 and the processing unit 420 contact and press each other, and portions of the insulating film 59 are removed from two opposite surfaces of the material coil 50 that are in contact with and pressed by the processing tool 340 and the processing unit 420.

The processing unit 420 may include a plurality of processing blades 422, and each of the processing blades 422 may be disposed parallel or perpendicular to the feeding path of the material coil 50. In addition, a cavity 424 is formed as an empty space between the processing blades 422. Processing by-products, such as pieces of insulating film 59 and processing chips generated during the stripping process and/or the notching process, may be stored in the cavity 414. The by-products, such as pieces of the insulating film 59 and processing chips, may be immediately discharged to the outside through a discharge path connected to the cavity 424.

A plurality of guide posts 430 is provided on the upper surface of the fixed die 400. The number and positions of the guide posts 430 correspond to those of the plurality of guide holes 360 formed in the movable die 300. Each of the guide posts 430 is a pillar-shaped member that extends straight vertically upward from the upper surface of the fixed die 400, and is made of a highly rigid material.

Each of the plurality of guide posts 430 passes through a corresponding one of the plurality of guide holes 360. The positions of the fixed die 400 and the movable die 300 are aligned in the upward-downward direction through the plurality of guide posts 430 inserted into the plurality of guide holes 360.

The movable die 300 is coupled to the plurality of guide posts 430 and thus is movable only in the +Z-axis direction.

The guide posts 430 may be provided with elastic units 432. Each of the elastic units 432 may be implemented as a compression spring that is provided so as to surround a portion of the outer periphery of a respective one of the guide posts 430.

When the movable die 300 approaches the fixed die 400 at a distance shorter than a predetermined distance, the elastic units 432 exert repulsive force between the fixed die 400 and the movable die 300.

The elastic units 432 reduce shock, vibration, noise, etc. that may occur in addition to external force for performing stripping or notching of the material coil 50 in an area in which the processing tool 340 and the processing unit 420 are in contact with each other, and facilitate a process of separating the processing tool 340 from the processing unit 420.

The fixed die 400 may further include a pair of alignment blocks 520. The pair of alignment blocks 520 is provided on both sides of the processing unit 420 with the processing unit 420 interposed therebetween. The alignment blocks 520 are disposed in pairs with the above-described lifting blocks 510 of the movable die 300.

The lifting blocks 510 and the alignment blocks 520, which constitute vice clamps 500, are mounted to the movable die 300 and the fixed die 400, respectively.

When the movable die 300 approaches the fixed die 400 and thus the processing surface of the processing tool 340 and the processing blade 422 of the processing unit 420 contact and press two opposite surfaces of the material coil 50, the vice clamps 500 firmly fix the material coil 50.

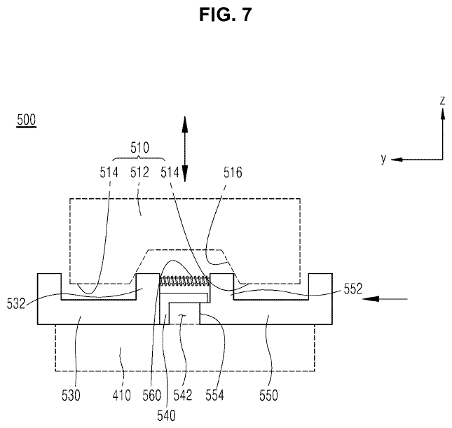

FIG. 7 is a schematic view for explaining the operational state of the vice clamps 500 in the apparatus 66 for removing the insulating film 59 according to the embodiment of the present disclosure.

As shown in FIG. 7, the vice clamps 500 are configured such that the lifting blocks 510 mounted to the movable die 300 and the alignment blocks 520 mounted to the fixed die 400 are paired with each other.

The vice clamps 500 may be disposed adjacent to both sides of the processing unit 420 and the processing tool 340, with the processing unit 420 and the processing tool 340 interposed therebetween, based on the feeding path of the material coil 50, and serve to firmly fix both ends of the material coil 50 when the processing tool 340 and the processing unit 420 contact the material coil 50 and remove the insulating film 59 from the material coil 50.

The lifting block 510 coupled to the movable die 300 includes a horizontal bar 512 formed to be elongated in the horizontal direction orthogonal to the longitudinal direction of the fed material coil 50, and vertical bars 514 are formed on both sides so as to protrude downward. The pair of vertical bars 514 is connected to the horizontal bar 512. A gap between surfaces of the two vertical bars 514 facing each other gradually increases in a direction away from the horizontal bar 512. The surfaces of the two vertical bars 514 facing each other, i.e., inclined surfaces, a gap between which gradually increases in a direction away from the horizontal bar 512, are contact portions 516.

The alignment block 520 is provided at the fixed plate 410. The alignment block 520 includes a reference block 530, a holding block 540, and a press block 550. The holding block 540 forms the coil feeding path 542, which is a space through which the material coil 50 passes, on the fixed plate 410. The holding block 540 forms the coil feeding path 542, which is a passage corresponding to the cross-section of the material coil 50, on the fixed plate 410.

The reference block 530 and the press block 550 are disposed on both sides of the holding block 540.

The reference block 530, the holding block 540, and the press block 550 are disposed in a row on the fixed plate 410 in that order. The reference block 530, the holding block 540, and the press block 550 are disposed to intersect a virtual straight line extending along the feeding path perpendicularly.

The reference block 530 includes a reference protrusion 532 protruding upward, and the press block 550 includes a variable protrusion 552 protruding upward.

When the lifting block 510 moves close thereto, the reference protrusion 532 and the variable protrusion 552 come into contact with the inclined surfaces formed by the contact portions 516 of the lifting block 510. That is, as the lifting block 510 approaches the alignment block 520, the reference block 530 and the press block 550 press the holding block 540 located at the center of the alignment block 520 through the reference protrusion 532 and the variable protrusion 552 that come into contact with the contact portions 516 of the lifting block 510.

The press block 550 may further include a coil holder 554 protruding toward the coil feeding path 542, which is the space defined by the holding block 540. When the reference block 530 and the press block 550 press the holding block 540 toward the center of the holding block 540 from both sides, the coil holder 554 may more firmly press and fix the outer periphery of the material coil 50 passing through the coil feeding path 542.

A restoring unit 560 may be provided between the reference block 530 and the press block 550. The restoring unit 560 serves as a compression spring. When the lifting block 510 approaches the alignment block 520 and thus the reference block 530 and the press block 550 press the holding block 540 from both sides, the restoring unit 560 is elastically compressed. When the lifting block 510 moves sufficiently away from the alignment block 520 and thus external force is eliminated, the restoring unit 560 restores the gap between the reference block 530 and the press block 550 to the original gap.

The lifting block 510 and the alignment block 520, which constitute the vice clamp 500, may be made of a highly rigid and elastic material.

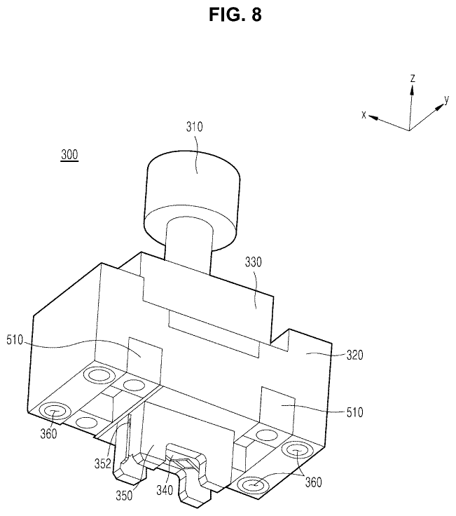

FIG. 8 is a bottom perspective view of the movable die 300 in the apparatus 66 for removing the insulating film 59 according to the embodiment of the present disclosure.

As shown in FIG. 8, the processing tool 340 is coupled to the center of the lower surface of the movable die 300. The processing tool 340 is surrounded by the pair of lifting blocks 510 and the pair of coil guides 350 on the lower surface of the movable die 300.

The feeding path of the material coil 50 extends in the +X-axis direction, and a straight line horizontally perpendicular to a virtual straight line extending along the feeding path of the material coil 50 is parallel to the Y-axis longitudinal direction.

The lifting blocks 510, which are disposed on both sides of the processing tool 340, are disposed on both sides of the processing tool 340 while extending along two straight lines parallel to the Y-axis.

In addition, the coil guides 350 are disposed adjacent to two side surfaces of the processing tool 340 along two straight lines parallel to the X-axis.

In detail, a feeding slit 352, which is a space through which the material coil 50 is capable of being fed in the longitudinal direction thereof, is formed between the pair of coil guides 350. The coil guides 350 are formed in the longitudinal direction on both sides of the processing tool 340 and thus guide the material coil 50 so that the material coil 50 passes through a position corresponding to the processing tool 340.

In addition, the pair of lifting blocks 510 may be disposed on both sides of the processing tool 340 so as to be horizontally perpendicular to the longitudinal direction of the material coil 50 that is fed.

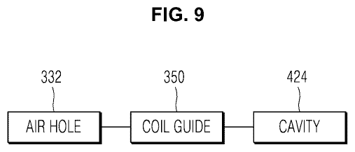

FIG. 9 is a block diagram schematically showing a path through which air is injected into the processing unit 420 in the apparatus 66 for removing the insulating film 59 according to the embodiment of the present disclosure.

As shown in FIG. 9, at least one air hole 332 may be formed in the main frame 320 and/or the sub-frame 330 of the movable die 300. The air hole 332 is an inlet into which high-pressure air is introduced from the outside. The air introduced into the air hole 332 may travel along a series of flow paths formed in the main frame 320 and/or the sub-frame 330. Then, the air introduced into the air hole 332 may be discharged toward a space surrounded by the coil guides 350, which is a space that the processing tool 340 faces. Alternatively, when the movable die 300 approaches the fixed die 400 and thus the distance between the processing tool 340 and the processing unit 420 is equal to or shorter than a predetermined distance, the air introduced into the movable die 300 through the air hole 332 may travel to a discharge nozzle provided in the space surrounded by the coil guides 350. Then, the air is discharged from the discharge nozzle toward the cavity 424 formed in the processing unit 420 at high pressure.

A series of processes in which air is introduced into the air hole 332, travels along the flow paths, and then is discharged toward the cavity 424 at high pressure may be performed by the controller.

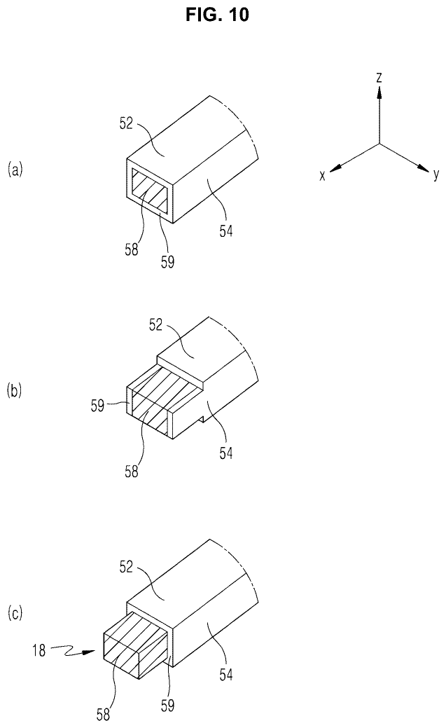

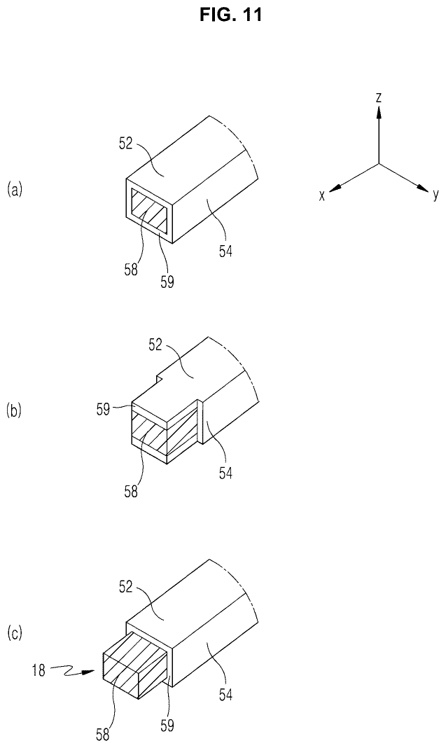

FIGS. 10 and 11 are views schematically showing a process in which the conductive terminal 18 is formed at an end of the material coil 50 by the apparatus 66 for removing the insulating film 59 according to the embodiment of the present disclosure.

As shown in the drawings, the stripping apparatus 66 according to the embodiment of the present disclosure is an apparatus that removes the insulating film 59 from a predetermined portion of the material coil 50.

In particular, in the case of a linear material coil 50 having a rectangular cross-section, the insulating film 59 may be removed corresponding to the angular cross-section.

The material coil 50 includes a linear conductive core 58, which has a rectangular cross-section and is disposed at the center thereof, and an insulating film 59, which is made of enamel and coated on the outer surface of the conductive core 58 to a predetermined thickness.

As shown in the drawings, the upper and lower surfaces of the material coil 50 are long side portions 52 corresponding to long sides of the rectangle, and the left and right surfaces of the material coil 50 are short side portions 54 corresponding to short sides of the rectangle.

In the stripping apparatus 66 according to the embodiment of the present disclosure, the first stripping unit 200 and the second stripping unit 202 are sequentially disposed, and the direction in which the movable die 300 and the fixed die 400 face each other in the first stripping unit 200 and the direction in which the movable die 300 and the fixed die 400 face each other in the second stripping unit 202 are set to be perpendicular to each other. That is, the direction in which the first stripping unit 200 contacts and presses the material coil 50 and the direction in which the second stripping unit 202 contacts and presses the material coil 50 are set to make 90 degrees with each other.

Thus, as shown in FIG. 10 (b), the first stripping unit 200 may remove the insulating film 59 from the upper and lower surfaces, i.e., the long side portions 52, of the material coil 50 passing through the coil feeding path 542. Thereafter, the material coil 50 may be fed to the second stripping unit 202 from the first stripping unit 200, and as shown in FIG. 10 (c), the insulating film 59 may be removed from the two remaining short side portions 54 of the material coil 50.

However, this is merely given by way of example. In another embodiment of the present disclosure, as shown in FIG. 11, the insulating film 59 may be primarily removed from the two short side portions 54 of the material coil 50 by the first stripping unit 200, and may be secondarily removed from the two remaining long side portions 52 of the material coil 50 by the second stripping unit 202. As is apparent from the above description, according to the present disclosure, since two parallel surfaces of a material coil having a rectangular cross-section are processed simultaneously, an insulating film may be removed from the material coil to a uniform thickness.

According to the present disclosure, since vice clamps are provided on both sides of a processing tool and a processing die for processing the surface of a material coil, the material coil may be firmly secured. Accordingly, a processing tolerance may be reduced, and processing quality may be improved.

According to the present disclosure, since air is injected into a cavity in a processing unit, it is possible to immediately remove processing by-products such as processing chips separated from a material coil.

The effects achievable through the disclosure are not limited to the above-mentioned effects, and other effects not mentioned herein will be clearly understood by those skilled in the art from the above description.

The embodiments of the present disclosure have been described above with reference to the accompanying drawings. However, the embodiments are only proposed for illustrative purposes, and the present disclosure is not limited to the above-described embodiments and the accompanying drawings.

It will be apparent to those skilled in the art that various changes in form and details may be made without departing from the scope and spirit of the disclosure. It is to be understood that the embodiments described herein are part of the present disclosure.

The embodiments described herein should not be construed as limiting the scope of the present disclosure. The scope of the present disclosure should be defined by the technical spirit set forth in the appended claims.

In addition, although not all actions or effects according to the configuration of the embodiments have been explicitly described, it is apparent that actions or effects predictable from the configuration should also be recognized as falling within the spirit and scope of the present disclosure.

What is claimed is:

1. A coil stripping apparatus configured to remove an insulating film from a surface of a material coil to manufacture a hairpin for a motor, the coil stripping apparatus comprising:
a base frame provided on an upper surface thereof with a guide rail;
at least two stripping units provided to be movable along the guide rail, the at least two stripping units being configured to face and press both sides of the material coil fed horizontally to remove an insulating film coated on the material coil; and
a controller configured to control movement and operation of the at least two stripping units on the base frame,
wherein the at least two stripping units comprise:
a first stripping unit disposed upstream based on a feeding path of the material coil; and
a second stripping unit disposed downstream of the first stripping unit.

2. The coil stripping apparatus according to claim 1, wherein the first stripping unit is configured to press the material coil to remove predetermined portions of the insulating film from the material coil.

3. The coil stripping apparatus according to claim 1, wherein the first stripping unit is configured to press an upper portion and a lower portion of the material coil to remove predetermined portions of the insulating film from an upper surface and a lower surface of the material coil.

4. The coil stripping apparatus according to claim 1, wherein the second stripping unit is configured to press the material coil to remove predetermined portions of the insulating film from the material coil.

5. The coil stripping apparatus according to claim 1, wherein the second stripping unit is configured to press both sides of the material coil to remove predetermined portions of the insulating film from both side surfaces of the material coil.

6. The coil stripping apparatus according to claim 1, wherein each of the first stripping unit and the second stripping unit comprises:
a main plate movably coupled to the guide rail;
an operating box coupled to an upper side of the main plate, the operating box being equipped with a vice holder configured to reciprocate along a predetermined straight path in accordance with operation of a servomotor;
a fixed die fixed to the main plate, the fixed die being provided on one surface thereof with a processing unit; and
a movable die connected to the vice holder to repeat operation of approaching and moving away from the processing unit.

7. The coil stripping apparatus according to claim 6, wherein the first stripping unit presses two opposite surfaces of the material coil in a Z-axis straight direction vertically perpendicular to an X-axis straight direction in which the material coil is fed, and
wherein the second stripping unit presses two opposite surfaces of the material coil in a Y-axis straight direction perpendicular both to the X-axis straight direction and to the Z-axis straight direction.

8. The coil stripping apparatus according to claim 6, wherein the movable die comprises a processing tool provided on a surface thereof facing the processing unit so as to press the material coil together with the processing unit to remove the insulating film.

9. The coil stripping apparatus according to claim 8, wherein each of the first stripping unit and the second stripping unit comprises a pair of vice clamps configured to secure the material coil, and
wherein the processing unit and the processing tool are located between the pair of vice clamps.

10. The coil stripping apparatus according to claim 9, wherein the pair of vice clamps comprises:
a pair of lifting blocks coupled to the movable die, with the processing tool interposed therebetween; and
a pair of alignment blocks provided at the fixed die, with the processing unit interposed therebetween, so as to respectively correspond to the pair of lifting blocks.

11. The coil stripping apparatus according to claim 10, wherein each of the pair of alignment blocks comprises:
a holding block having a coil feeding path formed therein as a passage through which the material coil passes;
a reference block provided in contact with one side of the holding block; and
a press block provided opposite the reference block so as to be in contact with another side of the holding block,
wherein, as the lifting block approaches the alignment block, the lifting block presses the reference block and the press block toward the holding block from both sides.

12. The coil stripping apparatus according to claim 11, wherein each of the pair of alignment blocks further comprises a restoring unit configured to push the reference block and the press block in opposite directions toward original positions thereof when a gap between the reference block and the press block is less than a predetermined gap.

13. The coil stripping apparatus according to claim 6, wherein the processing unit comprises:
at least one processing blade; and
a cavity formed around the at least one processing blade as a passage for discharge of a chip.

14. The coil stripping apparatus according to claim 13, wherein the movable die comprises at least one air hole formed therein to inject air into the cavity.

15. The coil stripping apparatus according to claim 1, wherein the coil stripping apparatus is configured to expose a conductive core.

16. A vehicle comprising the motor having the hairpin manufactured using the coil stripping apparatus of claim 1.

17. An electric vehicle comprising the motor having the hairpin manufactured using the coil stripping apparatus of claim 1.
